(19) United States
(12) Patent Application Publication
(10) Pub. No.: US 2004/0057707 A1
(43) Pub. Date: Mar. 25, 2004

(54) Heater

(76) Inventor: Leo Lamb, Liverpool (GB)

Correspondence Address: Charles N Quinn, 10th Floor, 2000 Market Street, Philadelphia, PA, 19103, US

(21) Appl. No.: 10/451,008

(22) PCT Filed: Dec. 18, 2001
(86) PCT No.: PCT/GB01/05616

(30) Foreign Application Priority Data
Dec. 19, 2000 (GB) 0030925.2
Jan. 24, 2001 (GB) 0101825.8

(51) Int. Cl. B01D 1/00

(52) U.S. Cl. 392/394

(57) ABSTRACT

A heater comprising a sealed container (4) having an internal partially evacuated cavity provided with at least one internal heating means (14), the cavity containing a working fluid, such as water, that vaporizes upon introduction of heat to the cavity from the heating means.

The present invention relates to an improved heater.

It is known to provide portable heaters, such as gas, electric or oil-filled heaters that are moveable to a desired position at a given time. Whilst these heaters provide a satisfactory means of heating, gas heaters may be hazardous due to the presence of a flame. Electric heaters and oil-filled heaters often require over 30 minutes to heat up to the required temperature. This is clearly undesirable given that portable heaters are generally used to provide a source of immediate heat in a particular room, rather than having to switch on the main central heating system and wait for the system to heat up the entire building. Additionally, pressure may build up in an oil-filled radiator during heating of the oil. This means that the material of the heater has to be of sufficient strength to withstand the pressure exerted thereon. This leads to an increase in the price of the heater and may result in the heater being more difficult to move. The oil also has to be re-cycled which, again, increases the price of the appliance.

Additionally, buildings may be heated by means of fixed radiators that are provided at intervals throughout the building. Water is heated by a main boiler and then delivered via pipes to the individual radiators. The water flows into subsidiary pipes provided in the radiator which results in the radiator heating up and releasing heat to the surroundings by means of radiation, conduction and convention.

However, the overall use of energy using these heaters is wasteful, requiring a great deal of energy to be expended in heating and maintaining the temperature of the water and pumping it around the building and then along the convoluted pipes contained within each radiator. The radiators are also subject to the build up of pressure This can result in damage occurring to the radiator and is potentially hazardous. Additionally, heating up of the radiators is quite slow and it is not possible to direct the hot water to only a single radiator.

It is an object of the present invention to provide an improved heater that aims to overcome, or at least alleviate, the above-mentioned drawbacks.

Accordingly, the present invention provides an improved heater comprising a sealed container having an internal partially evacuated cavity provided with an electrical element, the cavity containing an amount of water that vaporizes upon introduction of heat to the cavity from the electrical element, said water being present in a sufficient amount to ensure that the electrical element is always immersed in water during operation of the heater.

Additionally, the heating means may comprise a chamber or conduit through which a heat transfer medium, such as hot water, flows.

Preferably, the sealed container has a first chamber linked to ductwork. Preferably, the sealed container comprises a first chamber linked by ductwork to a second chamber. The heating means is preferably provided in the first chamber that acts as an expansion chamber.

Alternatively, the container may comprise A bottom chamber housing the at least one heating means, the chamber being in fluid communication with a series of conduits extending from the chamber. The conduits may run in the vertical and/or horizontal directions. Preferably, the conduits form a grid-like arrangement with the base of each vertical conduit being in fluid communication with the bottom chamber.

The first chamber, either in the form of an expansion chamber or bottom chamber may include two types of heating means to provide alternative sources of heat for heating the fluid in the chamber. For example, the fist chamber may be divided into compartments wherein one heating means is provided in one compartment and the other heating means is provided in another compartment. Preferably, one compartment is in fluid communication with the internal cavity of the container and the other is separate thereto. Preferably, a first pipe extends through the compartment that is separate to the internal cavity of the container. This pipe may be connected to a conventional hot water pipe system for delivering hot water to the bottom chamber. Preferably, the end of the pipe within the compartment is open to allow water to flow into the compartment. The compartment is preferably provided with an outlet that may be connected to a return pipe to deliver water away from the first chamber. The other heat source, such as an electrical heating element, is preferably provided in the other compartment of the chamber that is in fluid communication with the main internal cavity of the container.

Preferably, the container is made from a conductive material, such as a lightweight metal and is provided with means for partial evacuation thereof, such as a valve. The working fluid is preferably water.

The ratio of working fluid to the volume of the first internal cavity is preferably 1:20, more preferably 1:4 to 1:12; especially 1:8 to 1:12. A partial vacuum of approximately 99898.5 Nm⁻² (29 inch/Hg) is preferably provided within the cavity.

The base of the container may be provided with feet to support the heater. The inner sides of the internal cavity of the container should be protected against corrosive influence due to the presence of the working fluid therein.

For a better understanding of the present invention and to show more clearly how it may be carried into effect reference will now be made by way of example only to the accompanying drawings in which:

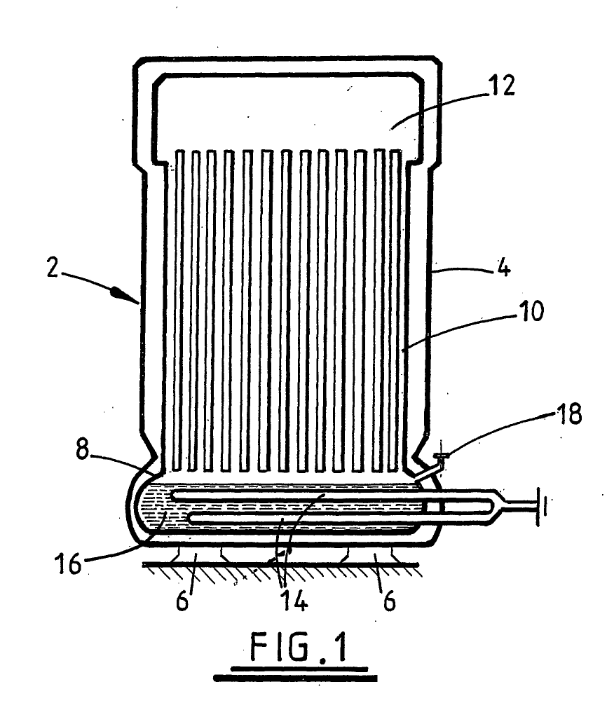

FIG. 1 is a cross-sectional view through the longitudinal plane of a heater according to one embodiment of the present invention;

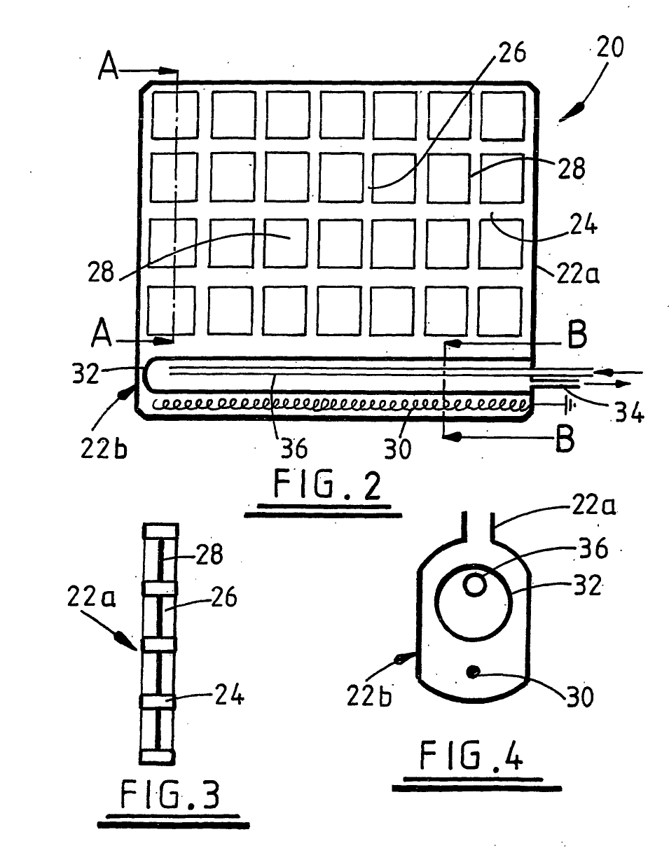

FIG. 2 is a longitudinal cross sectional view of a radiator according to another embodiment of the present invention;

FIG. 3 is a section along the line A-A shown in FIG. 2; and

FIG. 4 is a section along the line B-B shown in FIG. 2.

FIG. 1 of the accompanying drawings illustrates one embodiment of the present invention. The heater 2 comprises a metallic casing 4 supported by feet 6, the casing housing an expansion chamber or heat exchanger 8 that is linked by ductwork 10 to a top chamber or heat exchanger 12. A predetermined amount of fluid 16, such as water, is inserted into the base chamber 8 and the whole system (i.e. the chambers and ductwork) is partially evacuated by means of a valve 18.

A heat source, such as electrical heating elements 14, is provided through the expansion chamber. In this manner, switching on of the heat source heats the working fluid in the expansion chamber which evaporates below its normal boiling point due to the partial vacuum that exists in the system. The reduced pressure inside the heater also allows the fluid to move rapidly therethrough and, as it does so, condenses to release latent heat of condensation thereby transferring heat to the walls of the ductwork 10 and the top chamber 12 and hence, to the surrounding atmosphere.

The actual volume of the fluid contained in the interior cavity of the heater will depend upon the particular dimensions of the unit. It is important to ensure that the heating elements are always completely immersed in the working fluid 16 to obtain efficient operation of the heater. However, whilst the heating elements should always be immersed in the fluid, it is preferable to use as little working fluid as possible since the less working fluid, the lower the vacuum required and the shorter the time for the heater to heat up. Accordingly, it is preferable to use an element that does not extend too high in the heater. For a radiator having an internal capacity of 4.75 litres, around 400 ml (±25%) of fluid should be provided in the cavity. Generally, the ratio of fluid to the volume of the internal cavity of the radiator is between 1:20 preferably 1:4 to 1:12, more preferably 1:8 to 1:12. However, the exact amount will depend upon the position of the heating element and dimensions of the heater and heating element. Similarly, the amount of vacuum that exists in the heater is important for efficient operation thereof. Generally, quite a high vacuum is required, such as 29 inch/Hg (99898.5 Nm⁻²). The exact amount of vacuum and fluid required will depend upon the size of the chambers and ductwork and may be obtained by the law of thermodynamics.

It is to be appreciated that the inner walls of the system should be protected against corrosive influence due to the presence of a working fluid.

The heater is portable and relatively inexpensive to produce. The operation of the system at negative pressure provides a safer appliance since it does not have to withstand the positive pressures that are generally experienced when the medium in a radiator is heated to a high temperature. The heater of the present invention may achieve temperatures of 92° C. and still be at a negative pressure. This also enables the heater to be made of a lighter and thinner material due to the reduced pressure of the interior of the unit caused by the partial vacuum. Additionally, the heater heats up far more quickly than conventional portable heaters. For example, an oil-filled heater takes around forty minutes to heat up whereas a heater according to the present invention takes around five to nine minutes to heat up.

Referring to FIGS. 2 to 4 of the accompanying drawings, a radiator 20 according to another embodiment of the present invention is illustrated. The radiator comprises a partially evacuated chamber 22 having an upper part 22a and a lower part 22b. The upper part of the partially evacuated chamber is divided into a gridwork of horizontal and vertical conduits 24, 26, having square sheets 28 of material therebetween. However it is to be appreciated that the area between the conduits may be relieved of material. The chamber 22 contains a small amount of working fluid, such as water and has means (not shown) for evacuation of the chamber. A heating element 30, such as an electric heating element, is provided in the lower part 22b of the chamber, the element being immersed in working fluid during operation of the heater.

The lower part 22b of the chamber also contains a second heat source in the form of a pipe 36 that delivers a heat transfer medium to and from the radiator. The pipe 36 is contained within an inner cavity 32 provided in the lower part of the chamber 22b above the first heating element 30. The pipe 36 extends substantially throughout the length of the inner cavity 32, being open-ended within the cavity and being connected to a conventional hot water pipe (not shown) outside the cavity. The inner cavity 32 is provided with an outlet 34 which is connected to piping (not shown).

In this manner, the radiator may be heated by hot water supplied from the conventional heating system through the pipe 36 or by switching on the heating element 30. In the case of using hot water to heat up the radiator, the water is then recycled via outlet 34. The hot water in the inner cavity 32 heats up the working fluid in the partially evacuated chamber 22 which evaporates below its normal boiling point due to the partial vacuum that exists in the system. The reduced pressure in the cavity also allows fluid to move rapidly therethrough, in both the vertical and horizontal directions, and, as it does so, condenses to release latent heat of condensation thereby transferring heat to the walls of the chamber which transmits heat to its surroundings.

As mentioned in relation to FIG. 1, the actual volume of fluid contained in the interior cavity of the chamber will depend upon the particular dimensions of the unit. Similarly, the amount of vacuum that exists in the chamber is important for efficient operation thereof. The amount will depend upon the size of the pipes, the temperature required and the volume of working fluid and may be obtained by the law of thermodynamics.

The radiator according to this embodiment of the present invention has a number of advantages over those of the prior art. Firstly, the radiator does not require water to flow around the internal pipework running throughout the evacuated chamber. This reduces the pressure on the pump of the main heating system that delivers hot water around a building since it no longer has to pump the water around the convoluted pipes of a conventional radiator, it only has to deliver water to the base of the radiator. Additionally, the heater will normally operate at negative pressures up to approximately 100° C. depending on the fluid in the chamber. Thus, the unit will only have to withstand low pressures even at high temperatures. In contrast, the radiators of the prior art always have a positive pressure that increases as the temperature of the medium in the radiator rises. Not only does this result in the heating apparatus of the present invention being safer to use but the radiator may also be made of a lighter and thinner material due to the reduced pressure of the interior of the unit caused by the partial vacuum. A reduced volume of water also has to be heated and transported around the building thereby providing a far more efficient heating system. The improved heating system may also be run off existing pipework in buildings. Furthermore, the apparatus also enables the user to select a single radiator for heating using the secondary heating element without hot water having to be delivered around the whole system.

1. A heater comprising a sealed container (4) having an internal partially evacuated cavity provided with at least one internal heating means (14), the cavity containing a working fluid (16) that vaporizes upon introduction of heat to the cavity from the heating means.

2. A heater as claimed in claim 1 wherein the heating means is an electrical element (14).

3. A heater as claimed in. Claim 2 wherein the working fluid is present in a sufficient amount to ensure that the heating means is always immersed in fluid during operation of the heater.

4. A heater as claimed in claim 1 wherein the heating means comprises a chamber or conduit through which a heat transfer medium flows.

5. A heater as claimed in any one of the preceding claims wherein the sealed container (4) includes two types of heating means to provide alternative sources of heat for heating the fluid (16) in the container.

6. A heater as claimed in any one of claims 1 to 5 wherein the sealed container (4) comprises a first chamber (8) linked to ductwork (10).

7. A heater as claimed in claim 6 wherein the sealed container comprises a first chamber (8) linked by ductwork (10) to a second chamber (12).

8. A heater as claimed in claim 7 wherein the heating means (14) is provided in the first chamber (8) that acts as an expansion chamber.

9. A heater as claimed in any one of claims 1 to 6 wherein the first chamber comprises a bottom chamber (22b) housing at least one heating means, the chamber being in fluid communication with a series of conduits (24, 26) extending from the chamber.

10. A heater as claimed in claim 9 wherein the conduits run in vertical and/or horizontal directions.

11. A heater as claimed in claim 10 wherein the conduits form a grid-like arrangement with the base of each vertical conduit being in fluid communication with the bottom chamber (22b).

12. A heater as claimed in any one of claims 6 to 11 wherein the first chamber is divided into compartments wherein one heating means (36) is provided in one compartment and a different type of heating means (30) is provided in another compartment.

13. A heater as claimed in claim 12 wherein one compartment is in fluid communication with the internal cavity of the container and the other (32) is separate thereto.

14. A heater as claimed in claim 13 wherein a first pipe (36) for transportation of a heat transfer medium extends through the compartment (32) that is separate to the internal cavity of the container.

15. A heater as claimed in claim 14 wherein the pipe (32) is connected to a conventional hot water pipe for delivering hot water to the first chamber.

16. A heater as claimed in claim 14 or claim 15 wherein the end of the pipe (32) within the compartment is open to allow the heat transfer medium to flow into the compartment.

17. A heater as claimed in claim 14, 15 or 16 wherein the separate compartment (32) is provided with an outlet (34) that is connected to a return pipe to deliver the heat transfer medium away from the first chamber.

18. A heater as claimed in any one of claims 12 to 17 wherein the other heat source is provided in the other compartment of the chamber that is in fluid communication with the internal cavity of the container.

19. A heater as claimed in any one of the preceding claims wherein the container (4) is made of a conductive material and is provided with means (18) for partial evacuation thereof.

20. A heater as claimed in any one of the preceding claims wherein the ratio of the volume of working fluid to the volume of the internal cavity is 1:20.

21. A heater as claimed in claim 20 wherein the ratio of the volume of working fluid to the volume of the internal cavity is 1:4 to 1:12.

22. A heater as claimed in any one of the preceding claims wherein the internal cavity is provided with a partial vacuum of approximately 99898.5 Nm⁻².

23. A heater as claimed in any one of the preceding claims wherein the base of the heater is provided with feet (6) for support.

24. A heater as claimed in any one of the preceding claims wherein the inner sides of the internal cavity of the container are protected against corrosive influence.
